(19) United States
(12) Patent Application Publication
(10) Pub. No.: US 2023/0316946 A1
(43) Pub. Date: Oct. 5, 2023

(54) SYSTEM AND METHOD FOR VR TRAINING

(71) Applicant: 4THEVISION INC., Gyeonggi-do (KR)

(72) Inventor: A Bek LEE, Gyeonggi-do (KR)

(21) Appl. No.: 17/254,109

(22) PCT Filed: Oct. 8, 2019
(86) PCT No.: PCT/KR2019/013238

§ 371 Date: Jul. 12, 2022

(30) Foreign Application Priority Data
Oct. 7, 2019 (KR) 10-2019-0124086

(51) Int. Cl. G09B 9/00; G06F 3/01; G06T 15/00

(52) U.S. Cl. CPC G09B 9/00; G06F 3/011; G06T 15/00

(57) ABSTRACT

A system and method for VR training are provided. Exemplary embodiments are intended to reflect various situations and characteristics in an industrial site by interlocking with a state machine in a process of performing job training using VR contents, and to improve the efficiency of job training.

### PRIORITY

This application claims benefit under 35 U.S.C. 119(e), 120, 121, or 365(c), and is a National Stage entry from International Application No. PCT/KR2019/013238, filed Oct. 8, 2019 which claims priority to the benefit of Korean Patent Application No. 10-2019-0124086 filed in the Korean Intellectual Property Office on Oct. 7, 2019, the entire contents of which are incorporated herein by reference.

### TECHNICAL FIELD

Exemplary embodiments relate to a job training technology using VR contents.

### BACKGROUND ART

Recently, with the development of virtual reality (VR) technology, cases of incorporating VR technology in an industrial site are increasing. As an example, the utilization of VR technology in an industrial site is gradually increasing, such as conducting safety education experiences using VR technology in the industrial site, or conducting experience of manipulating facilities in the industrial site using VR technology.

However, the existing VR technology in the industrial site was limited to a user simply experiencing VR contents of a predetermined single scenario. Accordingly, there was a limit to reflecting various situations and characteristics at the industrial site, and accordingly, there was a difficulty in realizing an actual site situation or complex risk situation.

### SUMMARY

Exemplary embodiments are intended to reflect various situations and characteristics in an industrial site by interlocking with a state machine in a process of performing job training using VR contents and to improve efficiency of job training.

According to an exemplary embodiment, there is provided a system for VR training including a state machine that determines a next state according to a present state of each of data points according to a state-based logical relationship between the data points of each of set virtual objects, a VR agent that executes VR contents upon receiving contents data, which corresponds to the VR contents requested from a user, from an education management server, and receives an initial state of data points in the VR contents from the state machine, and a VR contents terminal that receives the initial state from the VR agent, visualizes output data according to the initial state through a display device, and transfers a present state of the data points in the VR contents, which corresponds to interaction data of the user collected while the VR contents is being executed according to the output data, to the VR agent, in which, when it is determined that the present state corresponding to the interaction data is an abnormal state that does not fit the logical relationship, the state machine transfers a request message to change the VR contents to the VR agent, and the VR contents terminal receives the request message to change the VR contents from the VR agent to transfer the request message to change the VR contents to the education management server, and receives a resource of the changed VR contents from the education management server to dynamically load the changed VR contents.

The education management server may manage a plurality of VR contents, and the VR agent may receive a list of the VR contents accessible to the user when the user logs in from the education management server and may cause, when receiving one of the VR contents in the list of the VR contents from the user, the VR contents to be executed upon receiving contents data corresponding to the received VR contents from the education management server.

Each of the VR contents may be VR contents for different types of job training.

The job training may include a job procedure based on a set emergency operations plan (EOP) or standard operating procedure (SOP).

The VR contents terminal may transfer progress data of the VR contents to the VR agent while the VR contents is being executed according to the output data, the state machine may receive a present state of data points in the VR contents corresponding to the progress data from the VR agent, and transfer a next state according to the present state of the data points in the VR contents to the VR agent based on the logical relationship, and the VR contents terminal may receive the next state according to the present state of the data points in the VR contents from the VR agent to reflect the next state to the VR contents currently being executed.

When the execution of the VR contents is terminated, the VR agent may receive the state of the data points in the VR contents from the VR contents terminal at a point in time when the execution of the VR contents is terminated, and transfer progress data, which includes the state of the data points in the VR contents at the point in time when the execution of the VR contents is terminated, to the education management server.

The education management server may manage progress data for each user, and derive improvements of the VR contents by analyzing the progress data for each user based on artificial intelligence (AI).

The education management server may transfer improvement data for simulating the improvements to the state machine, the state machine may change the logical relationship based on the improvement data and transfer change data according to the changed logical relationship to the education management server, and the education management server may change the VR contents based on the change data.

The education management server may change a content or job procedure in the VR contents.

When it is determined that the present state corresponding to the interaction data is a normal state according to the logical relationship, the state machine may transfer a next state according to the logical relationship to the VR agent, and the VR contents terminal may receive the next state from the VR agent to reflect the next state in the VR contents currently being executed.

According to another exemplary embodiment, there is provided a method for VR training using a state machine that generates output data according to a present state of each of data points according to a state-based logical relationship between the data points of each of set virtual objects, the method including executing, by a VR agent, VR contents upon receiving contents data, which corresponds to the VR contents requested from a user, from an education management server, receiving, by the VR agent, an initial state of data points in the VR contents from the state machine, receiving, by a VR contents terminal, the initial state from the VR agent, visualizing, by the VR contents terminal, output data according to the initial state through a display device, transferring, by the VR contents terminal, a present state of the data points in the VR contents, which corresponds to interaction data of the user collected while the VR contents is being executed according to the output data, to the VR agent, when it is determined that the present state corresponding to the interaction data is an abnormal state that does not fit the logical relationship, transferring, by the state machine, a request message to change the VR contents to the VR agent, receiving, by the VR contents terminal, the request message to change the VR contents from the VR agent to transfer the request message to change the VR contents to the education management server, and receiving, by the VR contents terminal, a resource of the changed VR contents from the education management server to dynamically load the changed VR contents.

The education management server may manage a plurality of VR contents, and, in the executing the VR contents, a list of the VR contents accessible to the user when the user logs in may be received from the education management server and the VR contents, when receiving one of the VR contents in a list of the VR contents from the user, may be caused to be executed upon receiving contents data corresponding to the received VR contents from the education management server.

Each of the VR contents may be VR contents for different types of job training.

The job training may include a job procedure based on a set emergency operations plan (EOP) or standard operating procedure (SOP).

The method for VR training may further include, after the visualizing the output data, transferring, by the VR contents terminal, progress data of the VR contents to the VR agent while the VR contents is being executed according to the output data, receiving, by the VR contents terminal, a present state of data points in the VR contents corresponding to the progress data from the VR agent, transferring, by the VR contents terminal, a next state according to the present state of the data points in the VR contents to the VR agent based on the logical relationship, and receiving, by the VR contents terminal, the next state according to the present state of the data points in the VR contents from the VR agent to reflect the next state to the VR contents currently being executed.

The method for VR training may further include, when the execution of the VR contents is terminated, receiving, by the VR agent, the state of the data points in the VR contents from the VR contents terminal at a point in time when the execution of the VR contents is terminated, transferring, by the VR agent, progress data, which includes the state of the data points in the VR contents at the point in time when the execution of the VR contents is terminated, to the education management server, and managing, by the education management server, progress data for each user.

The method for VR training may further include, after the managing the progress data for each user, deriving, by the education management server, improvements of the VR contents by analyzing the progress data for each user based on artificial intelligence (AI).

The method for VR training may further include, after the deriving the improvements of the VR contents, transferring, by the education management server, improvement data for simulating the improvements to the state machine, changing, by the state machine, the logical relationship based on the improvement data, transferring, by the state machine, change data according to the changed logical relationship to the education management server, and changing, by the education management server, the VR contents based on the change data.

In the changing the VR contents, a content or job procedure in the VR contents may be changed.

The method for VR training may further include, after the transferring the present state of the data points in the VR contents corresponding to the interaction data to the VR agent, when it is determined that the present state corresponding to the interaction data is a normal state according to the logical relationship, transferring a next state according to the logical relationship to the VR agent, and receiving, by the VR contents terminal, the next state from the VR agent to reflect the next state in the VR contents currently being executed.

According to an exemplary embodiment, in the process of performing job training utilizing the VR contents, a content and job procedure of the VR contents are dynamically changed according to a situation, instead of playing the VR contents according to a single predetermined job procedure, to reflect characteristics of more diverse and complex actual industrial sites, thereby capable of maximizing the effectiveness of job training.

In addition, according to an exemplary embodiment, an occurrence of an error in the job training process is determined and the VR contents are changed in real time when an error occurs, thereby capable of implementing a more diverse training situation and enriching the content of job training.

In addition, according to an exemplary embodiment, progress data for each user and a history of error occurrence are subjected to big data analysis to derive improvements to the content of VR contents and the job procedure, and accordingly, the VR contents are changed, thereby capable of improving efficiency of job training.

### BRIEF DESCRIPTION OF THE DRAWINGS

FIG. 1 is a detailed configuration diagram of a system for VR training according to an exemplary embodiment.

FIG. 2 is an example of a training ground according to an exemplary embodiment.

FIG. 3 is an of VR contents according to an exemplary embodiment.

FIG. 4 is a flowchart illustrating a process of executing the VR contents for the first time according to an exemplary embodiment.

FIG. 5 is a flow chart for describing a process in which the VR contents proceeds according to a predetermined job procedure according to an exemplary embodiment.

FIG. 6 is a flow chart for describing a process in which the VR contents proceeds according to user interaction, according to an exemplary embodiment.

FIG. 7 is a flowchart for describing a process of terminating the VR contents according to an exemplary embodiment.

FIG. 8 is a flowchart for describing a process of determining an error occurrence in a job training process and changing the VR contents in real time when an error occurs, according to an exemplary embodiment.

FIG. 9 is a flow chart for describing a process of deriving improvements to a content of the VR contents and job procedure, and changing the VR contents according to an exemplary embodiment.

FIG. 10 is an example in which the VR contents dynamically changes according to an exemplary embodiment.

FIG. 11 is a diagram for describing a data flow between a VR agent and a state machine when there are a plurality of users, according to an exemplary embodiment.

FIG. 12 is an example of an emergency operations plan (EOP) according to an exemplary embodiment.

FIG. 13 is a block diagram illustratively describing a computing environment including a computing device suitable for use in exemplary embodiments.

### DETAILED DESCRIPTION

Hereinafter, specific embodiments of the present invention will be described with reference to the accompanying drawings. The following detailed description is provided to aid in a comprehensive understanding of a method, a device and/or a system described in the present specification. However, the detailed description is only for illustrative purpose and the present invention is not limited thereto.

In describing the embodiments of the present invention, when it is determined that a detailed description of known technology related to the present invention may unnecessarily obscure the gist of the present invention, the detailed description thereof will be omitted. In addition, terms to be described later are terms defined in consideration of functions in the present invention, which may vary depending on intention or custom of a user or operator. Therefore, the definition of these terms should be made based on the content throughout this specification. The terms used in the detailed description are only for describing the embodiments of the present invention and should not be used in a limiting sense. Unless expressly used otherwise, a singular form includes a plural form. In this description, expressions such as “including” or “comprising” are intended to indicate any property, number, step, element, and some or combinations thereof, and such expressions should not be interpreted to exclude the presence or possibility of one or more other properties, numbers, steps, elements other than those described, and some or combinations thereof.

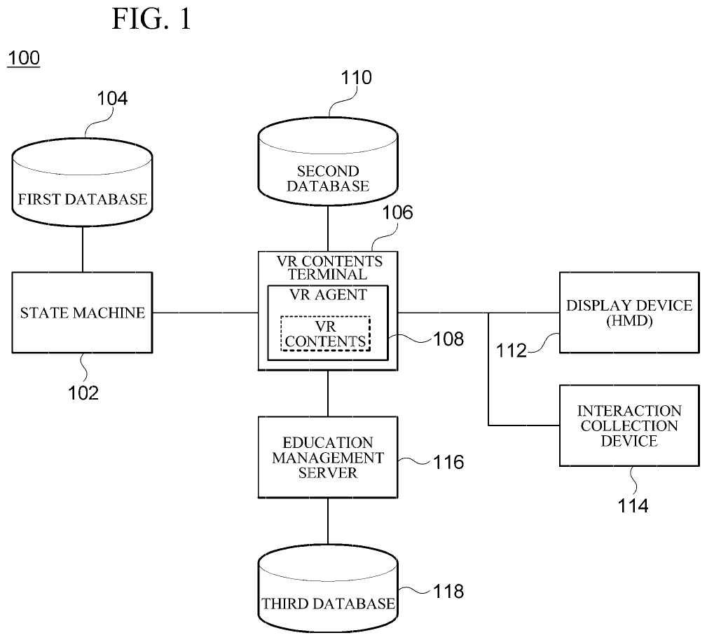

FIG. 1 is a detailed configuration diagram of a system for VR training 100 according to an exemplary embodiment. The system for VR training 100 according to an exemplary embodiment is a system for performing job training using VR technology, and can support, for example, implementation of job training in accordance with an emergency operations plan (EOP) or standard operating procedure (SOP) in an industrial site.

Here, the job training using VR technology refers to an act of constructing a virtual environment similar to an actual industrial site, by performing digital transformation on the space of the industrial site, various facilities or environments at the industrial site, and of virtually training job-related work procedures by a user while performing various interactions in the virtual environment. The user can perform various interactions while staring at VR contents for job training through a head mounted display (HMD).

In this case, the industrial site can be, for example, a power plant, a mine, a factory, a construction site, etc. In addition, the job training can be, for example, a generator maintenance work in a power plant, an electrical equipment work in a construction site, etc., but the type of job training is not particularly limited. In addition, the job training does not necessarily have to be limited to the industrial site, and all acts of training and educating workers, trainees, etc. in sequential work procedures in a specific field can be included in the job training described above.

On the other hand, as described above, the existing VR technology in the industrial site was limited to the user simply experiencing the VR contents of a predetermined single scenario. Accordingly, there was a limit to reflecting various situations and characteristics at the industrial site. Accordingly, the exemplary embodiments are interlocked with a state machine in the process of performing job training utilizing the VR contents to reflect various situations and characteristics in the industrial site and improve the efficiency of job training. Hereinafter, this will be described in more detail with reference to FIG. 1.

Referring to FIG. 1, the system for VR training 100 includes a state machine 102, a first database 104, a VR contents terminal 106, a VR agent 108, a second database 110, and a display device 112, an interaction collection device 114, an education management server 116, and a third database 118.

The state machine 102 determines a next state according to a present state of each of data points according to a state-based logical relationship between the data points each of set virtual objects and outputs the next state. That is, the state machine 102 is a logic machine that outputs a state change of data points according to an external data input, and is a device that defines the state of the data points and a situation that will occur in the future accordingly to enable simulation and manages the state and the situation. Here, a virtual object is an object in the VR contents corresponding to the real world, that is, various facilities, equipment, parts, or environments that constitute the industrial site, and can be, for example, an object representing an actuator, a valve, a pump, etc. in the VR contents. In addition, a data point is the smallest unit of an object capable of having two or more different states that are incompatible, and may be a virtual object itself or a component constituting the virtual object. As an example, the valve can be a virtual object and a data point having two states of lock/unlock. As another example, the actuator is a virtual object, and a motor constituting the actuator can be a data point having two states of on/off.

The VR contents can include a plurality of virtual objects and a plurality of data points, and the data points can affect other data points according to their present state. In addition, when states of the data points change, various situations can occur according to the state change. Based on these states of data points, a logical relationship between data points can be predefined by an administrator, and this logical relationship can be stored in the first database 104 to be described later. Here, when each of the data point is referred to as a node, the logical relationship refers to an input/output relationship or logic according to the state of each node.

As will be described later, the state machine 102 receives a request for an initial state of data points in the VR contents from the VR agent 108 for execution of the VR contents and accordingly, can transfer the initial state of the data points in the VR contents to the VR agent 108.

In addition, the state machine 102 can receive the present state of the data points in the VR contents from the VR agent 108 for the progress of the VR contents, and transfer the next state according to the logical relationship to the VR agent 108.

In addition, the state machine 102 receives the present state of the data points in the VR contents according to the interaction from the VR agent 108 when the user's interaction occurs while the VR contents is being executed, and determines whether or not the present state corresponding to the received interaction data is a normal state according to the logical relationship. The state machine 102, for example, can compare the state of each data point stored in the first database 104 with the present state of each data point according to the interaction to determine whether or not the present state is a normal state according to the logical relationship.

When it is determined that the present state corresponding to the received interaction data is the normal state according to the logical relationship, the state machine 102 can transfer a next state according to the logical relationship to the VR agent 108.

When it is determined that the present state corresponding to the received interaction data is an abnormal state that does not fit the logical relationship, the state machine 102 can record a present error state and transfer a request message to change the VR contents to the VR agent 108.

In addition, the state machine 102 can receive improvement data for simulating improvements of the VR contents from the education management server 116 after the execution of the VR contents is terminated, and perform a simulation based on the improvement data. As a result of the simulation, when it is determined that the improvements are appropriate, the state machine 102 can change the logical relationship based on the improvement data, and transfer change data according to the changed logical relationship to the education management server 116.

The first database 104 is a storage in which information of each of the data points and a state-based logical relationship between the data points are stored. The state machine 102 can refer to the first database 104 to determine a next state according to the present state of each of the data points.

The VR contents terminal 106 is a terminal on which the VR agent 108 is installed, and can be, for example, a desktop computer, a notebook computer, a tablet PC, etc. The VR contents terminal 106 can be interconnected with the state machine 102, the education management server 116, the display device 112, and the interaction collection device 114 through a network.

The VR agent 108 is software that processes various data related to the VR contents, or a computer-readable storage medium in which the software is installed, and can be installed on the VR contents terminal 106. The VR agent 108 can perform functions such as management of execution of VR contents, management of user' access rights, authentication and log collection, data relay related to VR contents, progress management of VR contents, and education score management of each user (trainee).

First, the VR agent 108 manages the execution of VR contents and the user's access rights. To this end, the VR agent 108 can provide a user interface (UI) for user login. The user can log in through the UI. The VR agent 108 can transfer user's information, that is, login information, to the education management server 116 when the user logs in, and receive a list of VR contents accessible to the user from the education management server 116 and display the list of the VR contents on the screen. As an example, assuming that user A has access rights to contents a to d, the VR agent 108 receives a list of contents a to d from the education management server 116 when user A logs in and display the list of contents a to d on the screen. The user can select one of the VR contents in the list. The VR agent 108 can request the education management server 116 for contents data corresponding to the selected VR contents and receive the contents data from the education management server 116. Here, the contents data can be the type, name, and identification number of the selected VR contents. The VR agent 108 causes the VR contents to be executed through the VR contents terminal 106, and accordingly, receives a request from the VR contents terminal 106 for initial states of data points in the VR contents. The VR agent 108 can request the state machine 102 for the initial state, receive the initial state from the state machine 102, and transfer the initial state to the VR contents terminal 106. Thereafter, the VR contents terminal 106 visualizes output data according to the initial state through the display device 112, and accordingly, the VR contents can be displayed on the display device 112.

In addition, after the VR contents is executed, the VR agent 108 receives progress data of the VR contents from the VR contents terminal 106 in real time and transfers the progress data to the state machine 102. Here, the progress data of the VR contents is data indicating to what stage the VR contents are currently executed after being executed and what the present state of each data point is. The state machine 102 can determine the next state based on the present state of each of data points included in the progress data, and then transfer a corresponding value to the VR agent 108. The VR agent 108 can transfer the next state to the VR contents terminal 106, and the VR contents terminal 106 reflect the next state to the VR contents. The VR contents terminal 106 visualizes the output data according to the next state through the display device 112, and accordingly, the VR contents corresponding to the next state can be displayed on the display device 112.

In addition, when user's interaction occurs while the VR contents are being executed, the VR agent 108 receives user's interaction data from the VR contents terminal 106 and transmits the user's interaction data to the state machine 102. Here, the interaction data is, for example, data input by interaction such as a user's voice, touch, click, gesture, manipulation of a manipulation tool (not illustrated), movement, gaze, etc., and can include a present state of each of data points according to the interaction. The state machine 102 can determine whether or not the present state corresponding to the interaction data is a normal state according to the logic relationship.

When it is determined that the present state corresponding to the received interaction data is the normal state according to the logical relationship, the VR agent 108 can receive the next state according to the logical relationship from the state machine 102.

When it is determined that the present state corresponding to the received interaction data is an abnormal state that does not fit the logical relationship, the VR agent 108 can receive a request message to change the VR contents from the state machine 102. In this case, the VR agent 108 can transfer the request message to change the VR contents to each of the education management server 116 and the VR contents terminal 106.

In addition, when the execution of the VR contents is terminated, the VR agent 108 receives the states of the data points in the VR contents at a point in time when the execution of the VR contents is terminated from the VR contents terminal 106, and transfers progress data, which includes the states of data points in the VR contents at the point in time when the execution of the VR contents is terminated, to the education management server 116. As will be described later, the education management server 116 manages progress data for each user, and can derive improvements of the VR contents based on this.

The second database 110 is a storage in which user's login information (ID, password, etc.), execution and access rights of each user for VR contents, billing information, etc. are stored.

The display device 112 is a device on which the VR contents are displayed, and can be, for example, a head mounted display (HMD). However, the type of the display device 112 is not particularly limited thereto.

The interaction collection device 114 collects user's interaction data while the VR contents is being executed. Here, the interaction refers to a process of outputting a corresponding output from the VR contents when a user gives an input to the VR contents for job training. The interaction collection device 114 can be, for example, a sensor, a manipulation tool, a camera, etc., and can be disposed at various locations such as located at a set point in the training ground or attached to the display device 112.

The education management server 116 is a device that manages VR contents, a content of the VR contents (i.e., contents itself), a job procedure, and user information. The education management server 116 can include an authoring tool (not illustrated), and can generate VR contents through the authoring tool. In addition, the education management server 116 may receive the VR contents from a content provider (not illustrated). The third database 118 can store the VR contents, user information, etc., and the education management server 116 can manage the VR contents, user information, etc. by interlocking with the third database 118.

As described above, the education management server 116 can receive the user's login information from the VR agent 108 when the user logs in, and transfer the list of the VR contents accessible to the user to the VR agent 108. The education management server 116 can manage a plurality of the VR contents, and each of the VR contents managed by the education management server 116 can be the VR contents for different types of job training. As an example, each of the VR contents can be, for example, VR contents for training generator maintenance work at a power plant, VR contents for training electric equipment work at a construction site, etc. In this case, the job training can include a set EOP or SOP-based job procedure. When the VR agent 108 receives one of the VR contents in the list of the VR contents from the user, the education management server 116 can transfer contents data corresponding to the input VR contents to the VR agent 108.

In addition, the education management server 116 can manage progress data of each VR contents for each user. When the execution of the VR contents is terminated, the education management server 116 can receive progress data including states of data points in the VR contents at the point in time when the execution of the VR contents is terminated from the VR agent 108, and can store the progress data in the third database 118. Thereafter, when the execution of the VR contents is requested again by the user, the education management server 116 can transfer the progress data to the VR agent 108. In this case, the user can participate again from a portion corresponding to the point in time when the VR contents is terminated.

In addition, the education management server 116 can analyze the progress data for each user based on artificial intelligence (AI) to derive improvements of the VR contents. The progress data can include a progression stage the VR contents at a point in time when the execution of the VR contents is terminated, states of data points in the VR contents, an error occurrence history, etc. The education management server 116 can derive improvements of the VR contents through a big data analysis method.

As an example, in the case where an error occurs due to repeated fall of a user at a specific point because there is no guide sign of a fall risk in a work environment where the user performs job training, the education management server 116 can derive improvements of the content of adding a guide sign at the corresponding specific point in the work environment. As another example, in a case where an error occurs due to the user continuing to pass a wrong path due to an incorrect route indication guidance for the user in a work environment where the user performs job training, the education management server 116 can derive improvements of the contents of modifying the route indication guide located at the specific point in the corresponding work environment. As another example, in a case where, when multiple users perform multi-training, user 1 goes to the location where user 3 is located and performs a specific task, and at the same time, user 3 goes to the location where user 1 is located and performs a specific task, but the time that user 1 and user 3 run is different and thus the task is not performed at the same time, the education management server 116 can derive improvements of the content that completely change the job procedure in the VR contents. In this way, the education management server 116 can derive improvements of the content of the VR contents or the content of changing the job procedure through the big data analysis method.

Thereafter, the education management server 116 can transfer improvement data for simulating the improvements to the state machine 102. The state machine 102 can perform a simulation based on the improvement data. When it is determined that the improvements are appropriate as a result of the simulation, the state machine 102 can change the logical relationship based on the improvement data, and transfer change data according to the changed logical relationship to the education management server 116.

The third database 118 is a storage in which data related to VR contents is stored. The third database 118 can store VR contents, user information, progress information of the VR contents, etc. In addition, the third database 118 can store 3D digital assets (e.g., virtual objects, data points, etc.), the emergency operations plan (EOP), the standard operating procedure (SOP), etc. that constitute the VR contents.

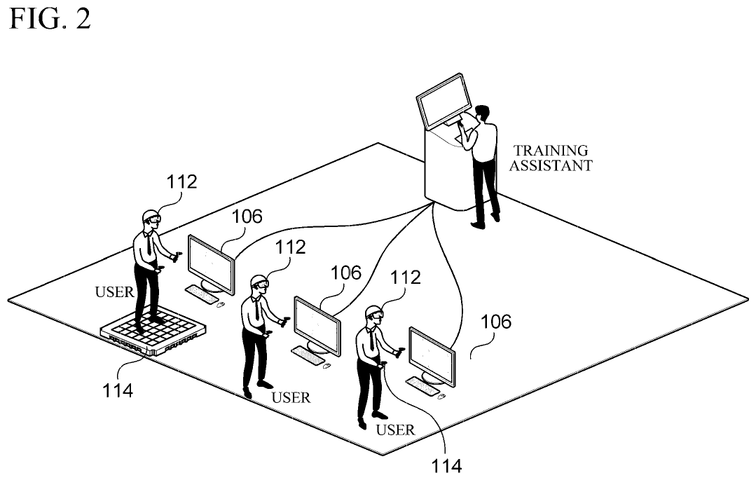

FIG. 2 is an example of a training ground according to an exemplary embodiment.

Referring to FIG. 2, the VR contents terminal 106, the display device 112, and the interaction collection device 114 can be disposed in the training ground. In this case, the user (i.e., the trainee) can perform job training while staring at the VR contents through the display device 112. In addition, the VR contents terminal 106 can include a VR agent (not illustrated), and can provide a UI for executing the VR contents through the VR agent. In this case, a plurality of users can simultaneously perform job training for one VR contents, and in this case, a VR agent exists for each user. In this multi-user training environment, each user can perform an interaction for job training in a virtual space, and interaction data of each user is collected by the interaction collection device 114. Here, the interaction collection device 114 can be, for example, a motion detection sensor attached to the floor of the training ground, a manipulation tool used to manipulate facilities in a virtual space while holding the tool in the user's hand, a camera that captures a video image of each user in the training ground, eye tracking device for tracking the user's gaze in the display device 112, etc.

In addition, as illustrated in FIG. 2, a training assistant can be disposed in the training ground to assist in job training of each user. The training assistant can monitor in real time the VR contents, the interaction of each user on the VR contents, and the progress of the VR contents currently being played through an administrator terminal. In this case, even with the same VR contents, the currently viewing point can be different for each user, and the training assistant can monitor the scene of the VR contents for each user's viewpoint in real time through the administrator terminal.

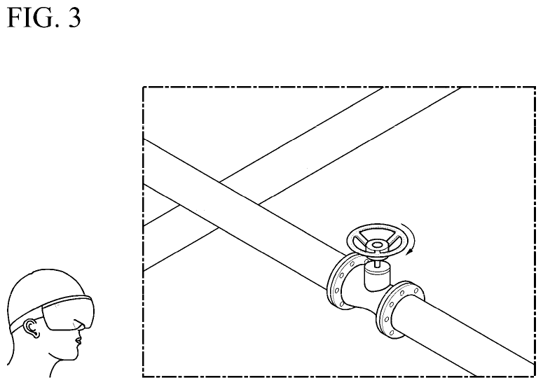

FIG. 3 is an example of the VR contents according to an exemplary embodiment.

Referring to FIG. 3, a user can stare at the VR contents while wearing an HMD or perform various interactions on the VR contents. The VR contents is a virtual environment implemented in a form similar to an actual industrial site by allowing a space of the industrial site, various facilities or environments at the industrial site to be subjected to digital transformation, and can include a UI for interaction with a user. The user can perform various interactions (e.g., gestures, clicks, touches, etc.) for job training while viewing the VR contents. As an example, the user can lock a valve by touching the valve (i.e., a virtual object) in the VR contents or manipulating a separate manipulation tool.

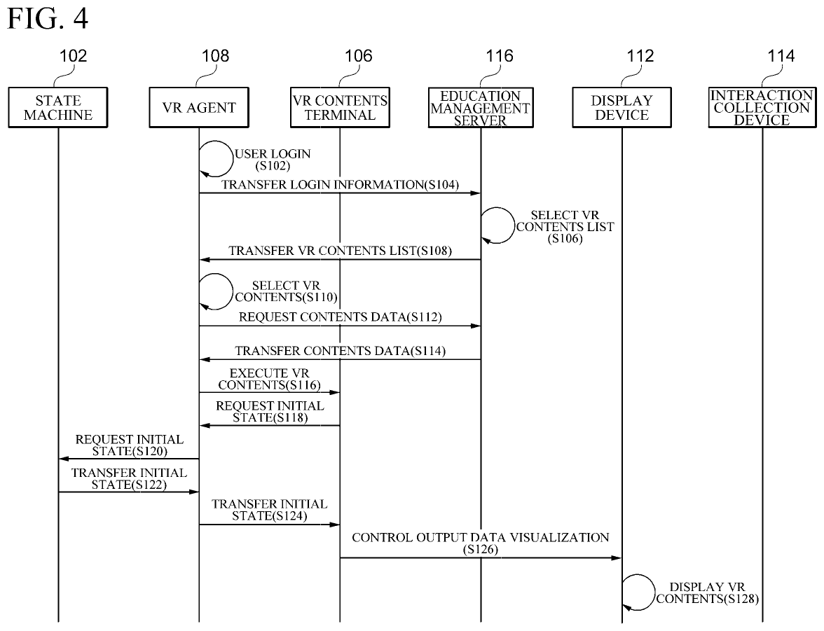

FIG. 4 is a flowchart illustrating a process of executing the VR contents for the first time according to an exemplary embodiment. In a flow chart illustrated below, the method is described by being divided into a plurality of steps, but at least some of the steps can be performed in a different order, performed together by being combined with other steps, omitted, performed by being divided into detailed steps, or performed by being added with one or more steps (not illustrated).

In step S102, the VR agent 108 receives a login request from the user. The VR agent 108 receives an ID, password, etc. for login from the user, and performs a login procedure of the user using the received ID, password, etc.

In step S104, the VR agent 108 transfers login information (i.e., user information) to the education management server 116 when the user's login is completed.

In step S106, the education management server 116 selects a list of the VR contents accessible to the user based on the login information.

In step S108, the education management server 116 transfers the list of the VR contents to the VR agent 108.

In step S110, the VR agent 108 receives one of the VR contents in the list of the VR contents from the user.

In step S112, the VR agent 108 requests the education management server 116 for contents data corresponding to the input VR contents.

In step S114, the education management server 116 transfers the contents data corresponding to the input VR contents to the VR agent 108.

In step S116, the VR agent 108 cause the VR contents to be executed through the VR contents terminal 106.

S118 In step S118, the VR contents terminal 106 requests the VR agent 108 for initial states of data points in the VR contents.

In step S120, the VR agent 108 requests the state machine 102 for the initial state.

In step S122, the state machine 102 transfers the initial state to the VR agent 108.

In step S124, the VR agent 108 transfers the initial state to the VR contents terminal 106.

In step S126, the VR contents terminal 106 controls the display device 112 to visualize the output data according to the initial state.

In step S128, the display device 112 displays the VR contents according to the output data.

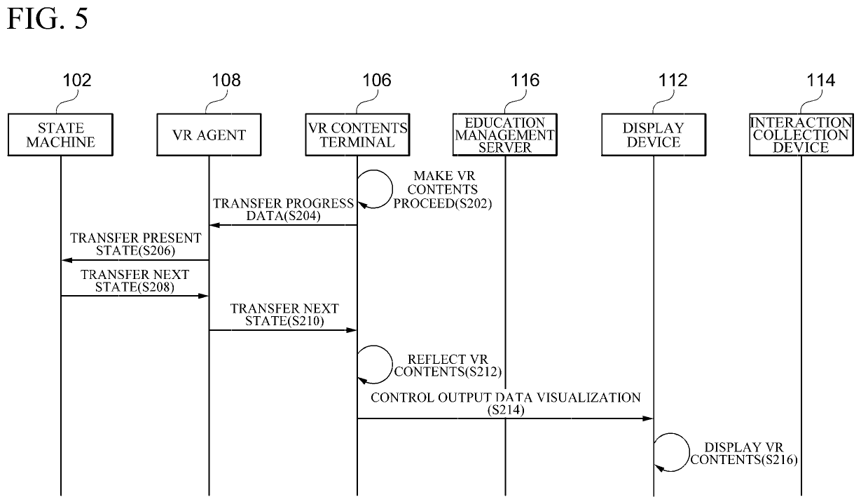

FIG. 5 is a flow chart for describing a process in which the VR contents proceeds according to a predetermined job procedure according to an exemplary embodiment.

In step S202, the VR contents terminal 106 continuously makes the VR contents proceed (i.e., maintains execution of the VR content) after step S128 of FIG. 4.

In step S204, the VR contents terminal 106 transfers progress data of the VR contents to the VR agent 108 while the VR contents is being executed.

In step S206, the VR agent 108 transfers the present state of each of data points included in the progress data to the state machine 102.

In step S208, the state machine 102 determines a next state according to the present state of each of the data points according to a predefined logical relationship, and transfers the next state to the VR agent 108.

In step S210, the VR agent 108 transfers the next state to the VR contents terminal 106.

In step S212, the VR contents terminal 106 reflects the next state to the VR contents currently being executed.

In step S214, the VR contents terminal 106 controls the display device 112 to visualize output data according to the next state.

In step S216, the display device 112 displays the VR contents according to the output data.

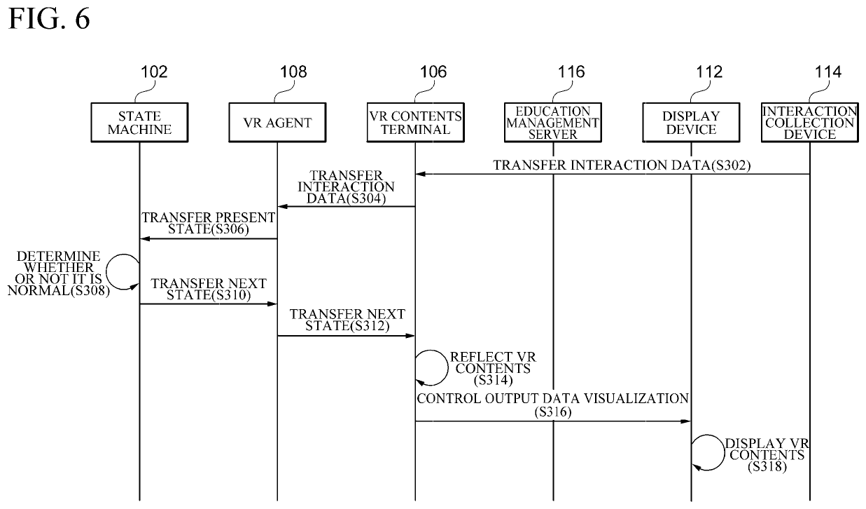

FIG. 6 is a flow chart illustrating a process in which the VR contents proceeds according to user interaction, according to an exemplary embodiment.

In step S302, the interaction collection device 114 collects user's interaction data while the VR contents is being executed, and transfers the user's interaction data to the VR contents terminal 106.

In step S304, the VR contents terminal 106 transfers the interaction data to the VR agent 108.

In step S306, the VR agent 108 transfers the present state of data points in the VR contents corresponding to the interaction data to the state machine 102.

In step S308, the state machine 102 determines whether or not the present state corresponding to the interaction data is a normal state according to the logic relationship.

In step S310, when the present state corresponding to the interaction data is the normal state according to the logical relationship as a result of the determination in step S308, the state machine 102 transfers a next state according to the logical relationship to the VR agent 108.

In step S312, the VR agent 108 transfers the next state to the VR contents terminal 106.

In step S314, the VR contents terminal 106 reflects the next state to the VR contents currently being executed.

In step S316, the VR contents terminal 106 controls the display device 112 to visualize output data according to the next state.

In step S318, the display device 112 displays the VR contents according to the output data.

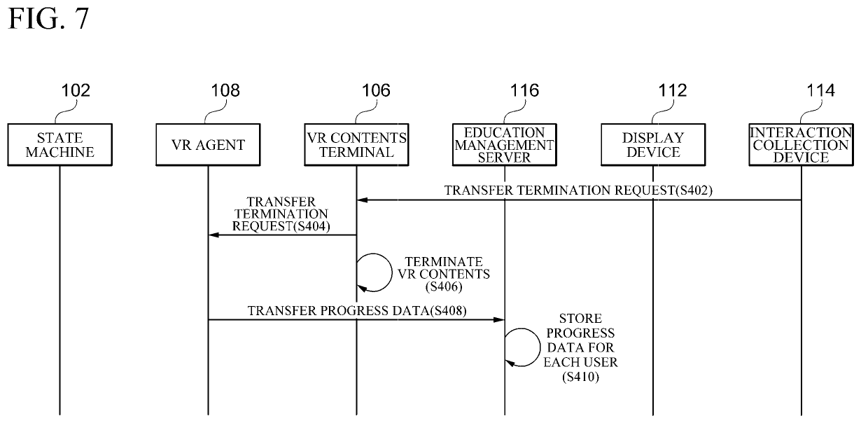

FIG. 7 is a flowchart for describing a process of terminating the VR contents according to an exemplary embodiment.

In step S402, the interaction collection device 114 collects a request to terminate the VR contents from the user and transfers the request to terminate the VR contents to the VR contents terminal 106. The request to terminate the VR contents is a type of interaction described above, and can be input by, for example, a user's voice, touch, click, gesture, manipulation of a manipulation tool (not illustrated), movement, gaze, etc.

In step S404, the VR contents terminal 106 transfers a request to terminate the VR contents to the VR agent 108.

In step S406, the VR contents terminal 106 terminates the execution of the VR contents according to the request to terminate the VR contents.

In step S408, the VR agent 108 transfers progress data, which includes states of data points in the VR contents at the point in time when the execution of the VR contents is terminated, to the education management server 116 upon receiving the request to terminate the VR contents.

In step S410, the education management server 116 stores the progress data for each user.

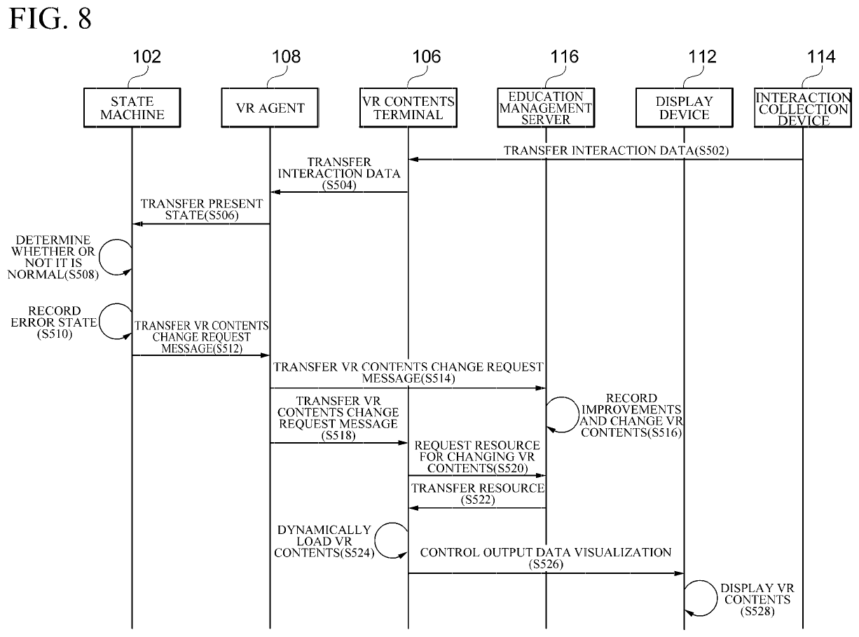

FIG. 8 is a flow chart illustrating a process of determining an error occurrence in a job training process and changing the VR contents in real time when an error occurs, according to an exemplary embodiment.

In step S502, the interaction collection device 114 collects user's interaction data while the VR contents is being executed, and transfers the user's interaction data to the VR contents terminal 106.

In step S504, the VR contents terminal 106 transfers the interaction data to the VR agent 108.

In step S506, the VR agent 108 transfers the present state of the data points in the VR contents corresponding to the interaction data to the state machine 102.

In step S508, the state machine 102 determines whether or not the present state corresponding to the interaction data is a normal state according to the logical relationship.

In step S510, the state machine 102 records a present error state when the present state corresponding to the interaction data is an abnormal state that does not fit the logical relationship as a result of the determination in step S808. Here, the present error state can include a stage of the VR contents at a point in time when an error occurs, a present state of each of data points, etc.

In step S512, the state machine 102 transfers a request message to change the VR contents to the VR agent 108.

In step S514, the VR agent 108 transfers the request message to change the VR contents to the education management server 116.

In step S516, the education management server 116 records improvements of the VR contents, and changes the VR contents by referring to the third database 118. For example, if an error occurrence is recorded in step S510 when the job procedure in the VR contents proceeds to \textcircled{1}→\textcircled{2}→\textcircled{3}, the education management server 116 can change the job procedure in the VR contents to A→B→C upon receiving the request message to change the VR contents from the VR agent 108 in step S514. Accordingly, the job procedure in the VR contents is changed in real time as follows.

Before change: \textcircled{1}→\textcircled{2}→\textcircled{3}
After change: A→B→C

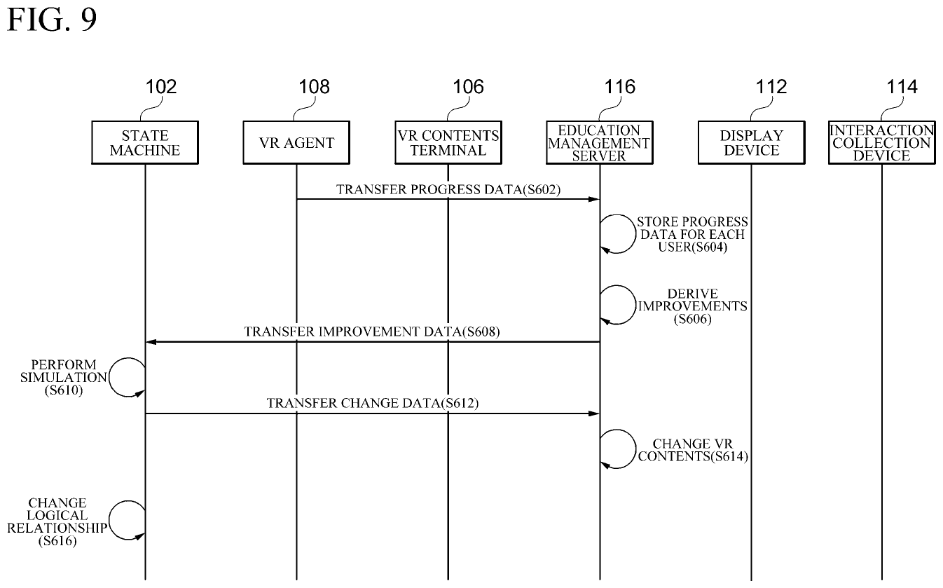

Such changes can be previously stored in the third database 118. For example, in the third database 118, contents of the VR contents, job procedures, etc. to be changed according to an error occurring in each stage can be stored in advance. In addition, the contents of the VR contents, job procedures, etc. to be changed in this way can be determined through the big data analysis method described above. This will be described later with reference to FIG. 9.

In step S518, the VR agent 108 transfers the request message to change the VR contents to the VR contents terminal 106.

In step S520, the VR contents terminal 106 requests a resource for changing the VR contents to the education management server 116.

In step S522, the education management server 116 transfers the resource for the VR contents to be changed to the VR contents terminal 106. Referring to the example descried above, the education management server 116 can transfer the resource of the VR contents for the job procedure A→B→C to the VR contents terminal 106.

In step S524, the VR contents terminal 106 dynamically loads the VR contents changed by using the resource received from the education management server 116.

In step S526, the VR contents terminal 106 controls the display device 112 to visualize output data of the changed VR contents.

In step S528, the display device 112 displays the VR contents according to the output data.

FIG. 9 is a flow chart for describing a process of deriving improvements to the content of the VR contents and the job procedure, and, accordingly, changing the VR contents according to an exemplary embodiment.

In step S602, when the execution of the VR contents is terminated, the VR agent 108 transfers progress data, which includes the states of the data points in the VR contents at the point in time when the execution of the VR contents is terminated, to the education management server 116.

In step S604, the education management server 116 stores the progress data for each user in the third database 118.

In step S606, the education management server 116 derives improvements of the VR contents by analyzing the progress data for each user based on artificial intelligence.

In step S608, the education management server 116 transfers improvement data for simulating the improvements to the state machine 102.

In step S610, the state machine 102 performs a simulation based on the improvement data.

In step S612, the state machine 102 transfers change data on the logical relationship to be changed according to the improvement data to the education management server 116 when it is determined that the improvements are appropriate as a result of the simulation in step S610.

In step S614, the education management server 116 changes the VR contents based on the change data. The education management server 116 can change the content or job procedure in the VR contents based on the change data. The VR contents changed in this way may be applied in the next VR training, and can also be applied in real time in the preceding step S516 while the VR contents is being executed.

In step S616, the state machine 102 changes the logical relationship based on the improvement data.

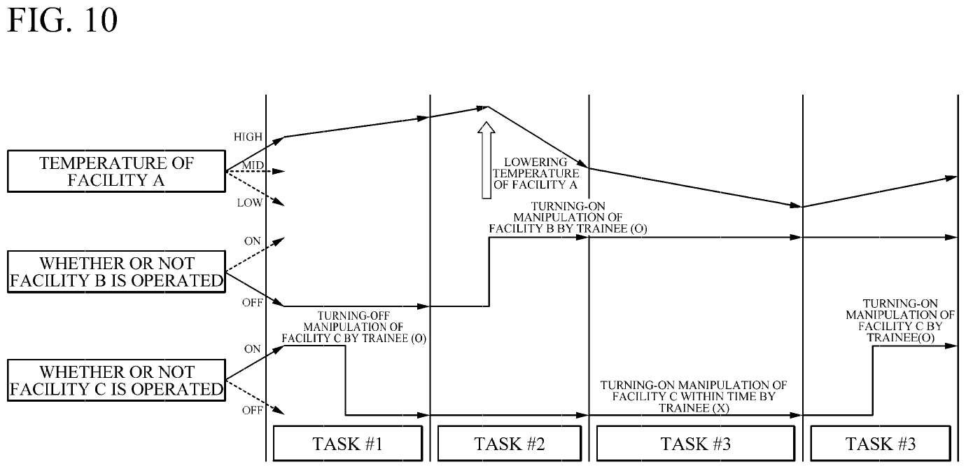

FIG. 10 is an example in which the VR contents dynamically change according to an exemplary embodiment.

Referring to FIG. 10, it is assumed that the initial state of each data point when the VR contents is executed is as follows.

Temperature of facility A: HIGH
Whether or not facility B is operated: OFF
Whether or not facility B is operated: ON

In addition, if task #1 is a task to be performed for the first time in the job procedure in VR the contents, the trainee can, for example, manipulate facility C to be turned OFF in the virtual environment to perform task #1. Due to this interaction, the state of each data point changes, and accordingly, the next task to be performed is determined as task #2. When the trainee lowers the temperature of facility A or manipulates facility B to be turned OFF in order to perform task #1, the next task to be performed can change to another task (for example, task #5) other than task #2. In addition, in task #3, when the trainer has to manipulate facility C to be turned ON but does not perform the turning-ON manipulation, task #3 can be maintained as the next task to be performed.

That is, the job procedure in the VR contents can be changed to task #1→task #2→task #3→task #3 according to user's interaction. Such change in the job procedure depends on the user's interaction, and if a different type of interaction is made from that in FIG. 6, the job procedure may be changed to task #1→task #5→task #4→task #3. The dynamic change in the job procedure is made through real-time interlocking with the state machine 102, and accordingly, a customized job procedure according to the situation can be provided to the user.

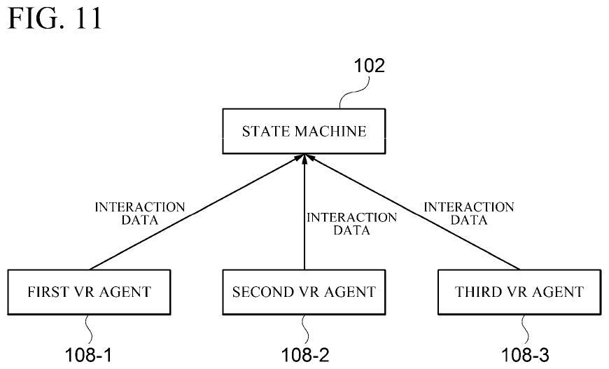

FIG. 11 is a diagram for describing a data flow between the VR agent 108 and the state machine 102 when there are multiple users, according to an exemplary embodiment. As described above, a plurality of users can simultaneously perform job training for one VR contents, and in this case, a VR agent exists for each user.

As an example, a first VR agent 108-1 for a first user, a second VR agent 108-2 for a second user, and a third VR agent 108-3 for a third user can be provided, respectively, and the VR agents 108-1, 108-2, and 108-3 are all connected to one state machine 102. Each of the VR agents 108-1, 108-2, and 108-3 transfers each user's interaction data to the state machine (102), and the state machine 102 can determine whether or not job training according to the VR contents is normally performed by combining interaction data of the users. For example, the state machine 102 can compare the state of each data point stored in the first database 104 with the present state of each data point included in the interaction data to determine whether or not the present state of each data point is a normal state according to a predefined logical relationship.

When it is determined that the present state is the normal state according to the logical relationship, the state machine 102 can transfer a next state according to the logical relationship to the VR agent 108.

When it is determined that the present state is an abnormal state that does not fit the logical relationship, the state machine 102 can record the present error state and transfer a request message to change the VR contents to the VR agent 108.

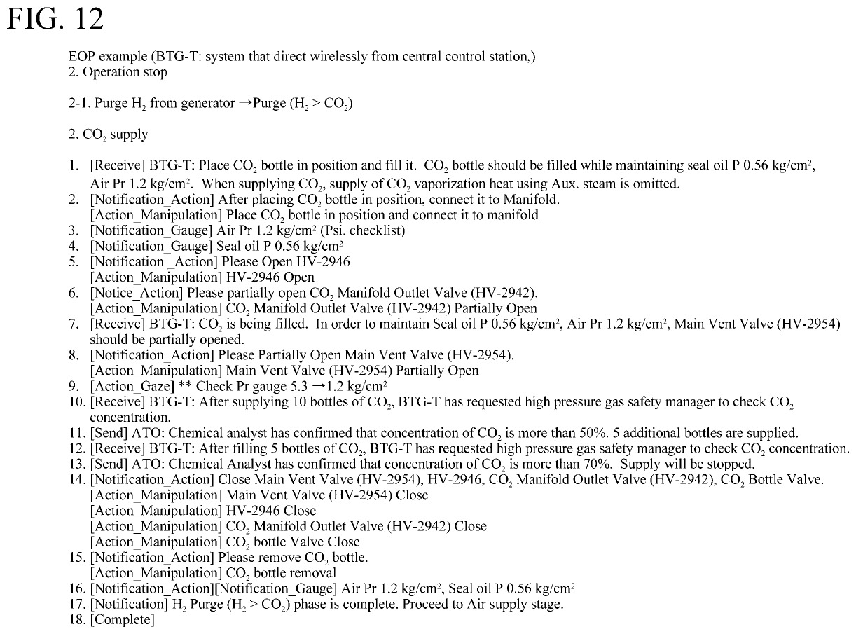

FIG. 12 is an example of an emergency operations plan (EOP) according to an exemplary embodiment. Referring to FIG. 12, the EOP can be, for example, a procedure document describing a procedure for supplying CO₂ in a generator in case of an emergency situation. As illustrated in FIG. 12, the EOP can include a sequential job procedure.

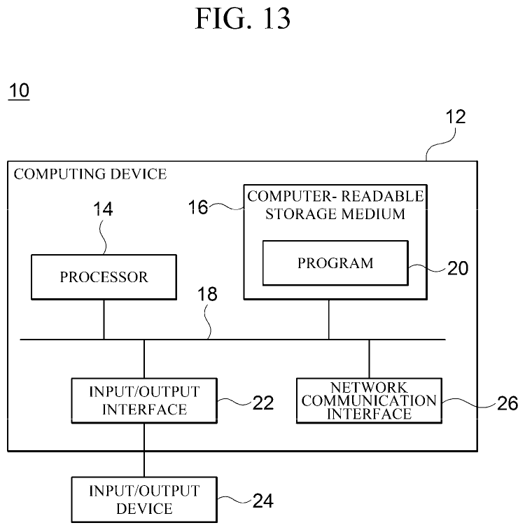

FIG. 13 is a block diagram illustratively describing a computing environment including a computing device suitable for use in exemplary embodiments. In the illustrated embodiment, each component can have different functions and capabilities in addition to those described below, and additional components can be included in addition to those described below.

The illustrated computing environment 10 includes a computing device 12. In one embodiment, the computing device 12 can be the system for VR training 100, or one or more components included in the system for VR training 100.

The computing device 12 includes at least one processor 14, a computer-readable storage medium 16, and a communication bus 18. The processor 14 can cause the computing device 12 to operate according to the exemplary embodiment described above. For example, the processor 14 can execute one or more programs stored on the computer-readable storage medium 16. The one or more programs can include one or more computer-executable instructions, which, when executed by the processor 14, can be configured to cause the computing device 12 to perform operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In one embodiment, the computer-readable storage medium 16 can be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 can also include one or more input/output interfaces 22 that provide an interface for one or more input/output devices 24, and one or more network communication interfaces 26. The input/output interface 22 and the network communication interface 26 are connected to the communication bus 18. The input/output device 24 can be connected to other components of the computing device 12 through the input/output interface 22. The exemplary input/output device 24 can include a pointing device (such as a mouse or trackpad), a keyboard, a touch input device (such as a touch pad or touch screen), a voice or sound input device, input devices such as various types of sensor devices and/or photographing devices, and/or output devices such as a display device, a printer, a speaker, and/or a network card. The exemplary input/output device 24 can be included inside the computing device 12 as a component constituting the computing device 12, or can be connected to the computing device 12 as a separate device distinct from the computing device 12.

Although the present invention has been described in detail through representative examples above, those skilled in the art to which the present invention pertains will understand that various modifications can be made thereto within the limit that do not depart from the scope of the present invention. Therefore, the scope of rights of the present invention should not be limited to the described embodiments, but should be defined not only by claims set forth below but also by equivalents of the claims.

What is claimed is:

1. A system for VR training, comprising:
a state machine that determines a next state according to a present state of each of data points according to a state-based logical relationship between the data points of each of set virtual objects;
a VR agent that executes VR contents upon receiving contents data, which corresponds to the VR contents requested from a user, from an education management server, and receives an initial state of data points in the VR contents from the state machine; and
a VR contents terminal that receives the initial state from the VR agent, visualizes output data according to the initial state through a display device, and transfers a present state of the data points in the VR contents, which corresponds to interaction data of the user collected while the VR contents is being executed according to the output data, to the VR agent,
wherein, when it is determined that the present state corresponding to the interaction data is an abnormal state that does not fit the logical relationship, the state machine transfers a request message to change the VR contents to the VR agent; and
the VR contents terminal receives the request message to change the VR contents from the VR agent to transfer the request message to change the VR contents to the education management server, and receives a resource of the changed VR contents from the education management server to dynamically load the changed VR contents.

2. The system of claim 1, wherein the education management server manages a plurality of VR contents; and
the VR agent receives a list of the VR contents accessible to the user when the user logs in from the education management server and causes, when receiving one of the VR contents in the list of the VR contents from the user, the VR contents to be executed upon receiving contents data corresponding to the received VR contents from the education management server.

3. The system of claim 2, wherein each of the VR contents is VR contents for different types of job training.

4. The system of claim 3, wherein the job training includes a job procedure based on a set emergency operations plan (EOP) or standard operating procedure (SOP).

5. The system of claim 1, wherein the VR contents terminal transfers progress data of the VR contents to the VR agent while the VR contents is being executed according to the output data;
the state machine receives a present state of data points in the VR contents corresponding to the progress data from the VR agent, and transfers a next state according to the present state of the data points in the VR contents to the VR agent based on the logical relationship; and
the VR contents terminal receives the next state according to the present state of the data points in the VR contents from the VR agent to reflect the next state to the VR contents currently being executed.

6. The system of claim 1, wherein, when the execution of the VR contents is terminated, the VR agent receives the state of the data points in the VR contents from the VR contents terminal at a point in time when the execution of the VR contents is terminated, and transfers progress data, which includes the state of the data points in the VR contents at the point in time when the execution of the VR contents is terminated, to the education management server.

7. The system of claim 6, wherein the education management server manages progress data for each user, and derives improvements of the VR contents by analyzing the progress data for each user based on artificial intelligence (AI).

8. The system of claim 7, wherein the education management server transfers improvement data for simulating the improvements to the state machine;
the state machine changes the logical relationship based on the improvement data and transfers change data according to the changed logical relationship to the education management server; and
the education management server changes the VR contents based on the change data.

9. The system of claim 8, wherein the education management server changes a content or job procedure in the VR contents.

10. The system of claim 1, wherein, when it is determined that the present state corresponding to the interaction data is a normal state according to the logical relationship, the state machine transfers a next state according to the logical relationship to the VR agent; and
the VR contents terminal receives the next state from the VR agent to reflect the next state in the VR contents currently being executed.

11. A method for VR training using a state machine that generates output data according to a present state of each of data points according to a state-based logical relationship between the data points of each of set virtual objects, the method comprising:
executing, by a VR agent, VR contents upon receiving contents data, which corresponds to the VR contents requested from a user, from an education management server;
receiving, by the VR agent, an initial state of data points in the VR contents from the state machine;
receiving, by a VR contents terminal, the initial state from the VR agent;
visualizing, by the VR contents terminal, output data according to the initial state through a display device;
transferring, by the VR contents terminal, a present state of the data points in the VR contents, which corresponds to interaction data of the user collected while the VR contents is being executed according to the output data, to the VR agent;
when it is determined that the present state corresponding to the interaction data is an abnormal state that does not fit the logical relationship, transferring, by the state machine, a request message to change the VR contents to the VR agent;
receiving, by the VR contents terminal, the request message to change the VR contents from the VR agent to transfer the request message to change the VR contents to the education management server; and
receiving, by the VR contents terminal, a resource of the changed VR contents from the education management server to dynamically load the changed VR contents.

12. The method of claim 11, wherein the education management server manages a plurality of VR contents; and
in the executing the VR contents, a list of the VR contents accessible to the user when the user logs in is received from the education management server and the VR contents, when receiving one of the VR contents in a list of the VR contents from the user, is caused to be executed upon receiving contents data corresponding to the received VR contents from the education management server.

13. The method of claim 12, wherein each of the VR contents is VR contents for different types of job training.

14. The method of claim 13, wherein the job training includes a job procedure based on a set emergency operations plan (EOP) or standard operating procedure (SOP).

15. The method of claim 11, further comprising:
after the visualizing the output data, transferring, by the VR contents terminal, progress data of the VR contents to the VR agent while the VR contents is being executed according to the output data;
receiving, by the VR contents terminal, a present state of data points in the VR contents corresponding to the progress data from the VR agent;
transferring, by the VR contents terminal, a next state according to the present state of the data points in the VR contents to the VR agent based on the logical relationship; and
receiving, by the VR contents terminal, the next state according to the present state of the data points in the VR contents from the VR agent to reflect the next state to the VR contents currently being executed.

16. The method of claim 11, further comprising:
when the execution of the VR contents is terminated, receiving, by the VR agent, the state of the data points in the VR contents from the VR contents terminal at a point in time when the execution of the VR contents is terminated;
transferring, by the VR agent, progress data, which includes the state of the data points in the VR contents at the point in time when the execution of the VR contents is terminated, to the education management server; and
managing, by the education management server, progress data for each user.

17. The method of claim 16, further comprising:
after the managing the progress data for each user, deriving, by the education management server, improvements of the VR contents by analyzing the progress data for each user based on artificial intelligence (AI).

18. The method of claim 17, further comprising:
after the deriving the improvements of the VR contents, transferring, by the education management server, improvement data for simulating the improvements to the state machine;
changing, by the state machine, the logical relationship based on the improvement data;
transferring, by the state machine, change data according to the changed logical relationship to the education management server; and
changing, by the education management server, the VR contents based on the change data.

19. The method of claim 18, wherein, in the changing the VR contents, a content or job procedure in the VR contents is changed.

20. The method of claim 11, further comprising:
after the transferring the present state of the data points in the VR contents corresponding to the interaction data to the VR agent, when it is determined that the present state corresponding to the interaction data is a normal state according to the logical relationship, transferring a next state according to the logical relationship to the VR agent; and
receiving, by the VR contents terminal, the next state from the VR agent to reflect the next state in the VR contents currently being executed.
